(19) United States
(12) Patent Application Publication
(10) Pub. No.: US 2026/0069483 A1
(43) Pub. Date: Mar. 12, 2026

(54) DEVICE FOR INCREASING MOBILITY AND FLEXIBILITY OF A BODY

(71) Applicant: David Hopper, Batavia, IL (US)

(72) Inventors: David Hopper, Batavia, IL (US); John Stanevicius, Geneva, IL (US)

(21) Appl. No.: 19/320,988

(22) Filed: Sep. 5, 2025

Related U.S. Application Data
(60) Provisional application No. 63/691,588, filed on Sep. 6, 2024.

(51) Int. Cl. A61H 1/02; A61H 1/00; A61H 15/00

(52) U.S. Cl. CPC A61H 1/0296; A61H 1/005; A61H 2015/0028; A61H 2201/0157; A61H 2201/1609; A61H 2201/1623; A61H 2201/1635

(57) ABSTRACT

A device is for increasing mobility and/or flexibility of a body including a spine. The device includes a frame and a platform disposed on the frame. The platform has an opening. The device also includes an arcuate body rotatably supported about a rotation axis by the device such that at least a portion of the arcuate body is disposed within the opening. The arcuate body may include a yoga wheel, a foam roller, a ball, or the like.

### RELATED APPLICATION DATA

This patent claims priority to and the benefit of co-pending U.S. Provisional Application No. 63/691,588, filed Sep. 6, 2024, and entitled “Device for Increasing Mobility and Flexibility of a Body. ” The entire contents of this prior filed application are hereby incorporated by this reference.

### FIELD OF THE DISCLOSURE

The present disclosure relates to a device for increasing mobility and/or flexibility of a body, and more specifically, to a device for increasing mobility and/or flexibility of a spine and other parts of the body of a user.

### DESCRIPTION OF RELATED ART

Spinal disorders and mobility issues are continuously increasing. A yoga wheel, foam roller, ball, or the like is a tool that may be used to increase flexibility and enhance body balance. The yoga wheel, the foam roller, or the ball typically has a circular or spherical shape and serves as a tool to mobilize the spine and release restrictions in the spine, open the chest, shoulders, and hips. However, for beginners or users with significant physical limitations and much of the average population, the yoga wheel, the foam roller, or a ball can be challenging to use. Further, improper use of the yoga wheel, the foam roller, or a ball for example, pushing beyond the user's physical limits may lead to injuries.

### SUMMARY

According to an embodiment of the present disclosure, a device is for increasing mobility and flexibility of a body including a spine. The device includes a frame and a platform disposed on the frame. The platform has an opening. The device also includes an arcuate body rotatably supported about a rotation axis by the device such that at least a portion of the arcuate body is disposed within the opening.

The frame may have an opening that is aligned with or coincides with the opening in the platform.

The device may further include one or more rollers configured to rotatably support the arcuate body within the opening.

The arcuate body may merely rest on the one or more rollers.

The arcuate body may interact with the one or more rollers.

The one or more rollers may allow the arcuate body to be rotated within an area defined by the opening.

The one or more rollers may be configured to allow the arcuate body to be rotated without changing a position of the rotation axis relative to the device.

The arcuate body may be removable from and usable by a user separate from the device.

The device may further include a first bar and a second bar each positionable in an upright configuration extending vertically upward beyond the platform.

The first bar may be connected to a first side of the frame and the second bar may be connected to a second side of the frame opposite the first side.

The first bar and the second bar may be selectively movable between the upright configuration and a horizontal configuration.

The first bar and the second bar may be generally parallel with the platform in the horizontal configuration.

The device may further include a resistance band configured to be placed on an upper surface of the platform. The resistance band may be fixable to at least one of the platform or the frame via at least two points.

The platform may include a board or plank and a support cushion on an upper side of the board or plank.

The device may further include a plurality of wheels connected to the device and configured to movably support the device on a surface.

According to another embodiment of the present disclosure, a device is for increasing mobility and flexibility of a body. The device includes a platform having an opening within a perimeter of the platform and includes a yoga wheel rotatably supported for rotation such that at least a portion of the yoga wheel is disposed within the opening.

The yoga wheel may rotate about a rotation axis that is parallel with a support surface of the platform.

The rotation axis may be disposed across the opening though not necessarily co-planar with the platform.

The device may further include a neck traction tool configured to be removably placed on the upper surface of the platform such that a user can position the neck traction tool behind the user's neck to stretch or relax the neck when the user lies down on the platform.

The device may further include a hook coupled to the device and configured to be used to increase a reach of a user to a part of the body or release tension in muscles, facial adhesions, and other soft tissues limitations from all areas over the body.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention should become apparent upon reading the following description in conjunction with the drawing figures.

FIG. 1 is a top perspective view of a device for increasing mobility and/or flexibility of a body according to an embodiment of the present disclosure.

FIG. 2 is a bottom perspective view of the device according to an embodiment of the present disclosure.

FIG. 3 is a side view of the device according to an embodiment of the present disclosure.

FIG. 4 is an end on or front view of the device according to an embodiment of the present disclosure.

FIG. 5 is a top view of the device according to an embodiment of the present disclosure.

FIG. 6 is a bottom view of the device according to an embodiment of the present disclosure.

FIG. 7 is a cross-sectional view of the device, as defined by section line 4A-4B in FIG. 4 according to an embodiment of the present disclosure.

FIG. 8 is a top exploded view of the device according to an embodiment of the present disclosure.

FIG. 9 is a bottom exploded view of the device according to an embodiment of the present disclosure.

FIG. 10 is an exploded view of the device and illustrating a frame, rollers, first and second bars and latching devices thereof, and their connections according to an embodiment of the present disclosure.

FIG. 11 is an exploded view illustrating how the rollers are coupled to the frame of the device according to an embodiment of the present disclosure.

FIG. 12 is a perspective view of a yoga wheel according to an embodiment of the present disclosure.

FIG. 13 is a perspective view illustrating the device according to another embodiment of the present disclosure.

FIGS. 14, 15A, and 15B show a traction device used in concert with the device according to the teachings of the present disclosure.

### DETAILED DESCRIPTION OF THE DISCLOSURE

According to an embodiment, a device is provided for increasing mobility and/or flexibility of a body of a user, and more specifically, to a device for increasing mobility and/or flexibility of a spine and other parts of the body.

The device may be of any shape, or simply a supported frame. In some embodiments, the device may include a main body having a table-like structure supported on wheels. The main body has a hole or opening in the middle for an arcuate body to be placed therein. The arcuate body may take the form of a full cylinder, spherical, or a half-round configuration. For example, the arcuate body may include a yoga wheel, foam roller with or without grooves, ball with or without grooves, or the like. There may be two uprights on either side of the main body for a user to engage with while using the device. In addition, the device may include a neck traction device (i.e., a neck traction tool) that may be placed on the main body. The device may further include a resistance band that may be placed over the user's forehead to create additional traction on the cervical spine.

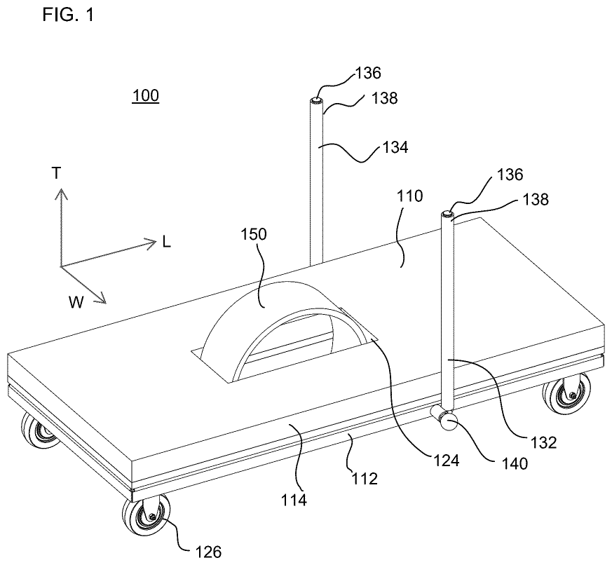

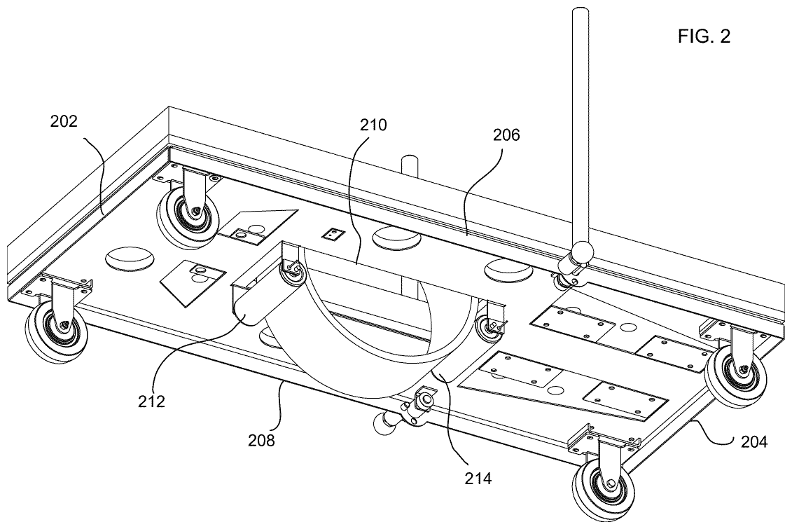

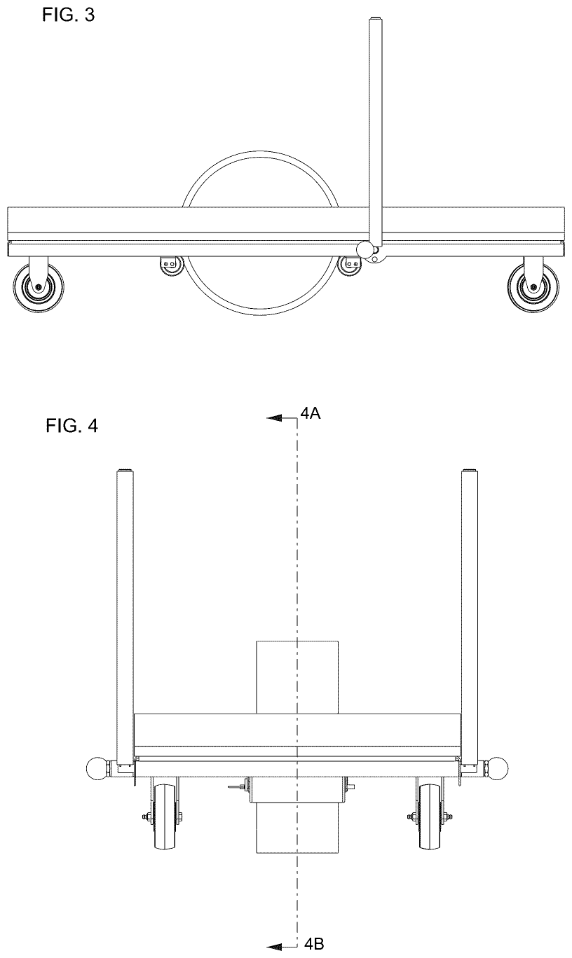

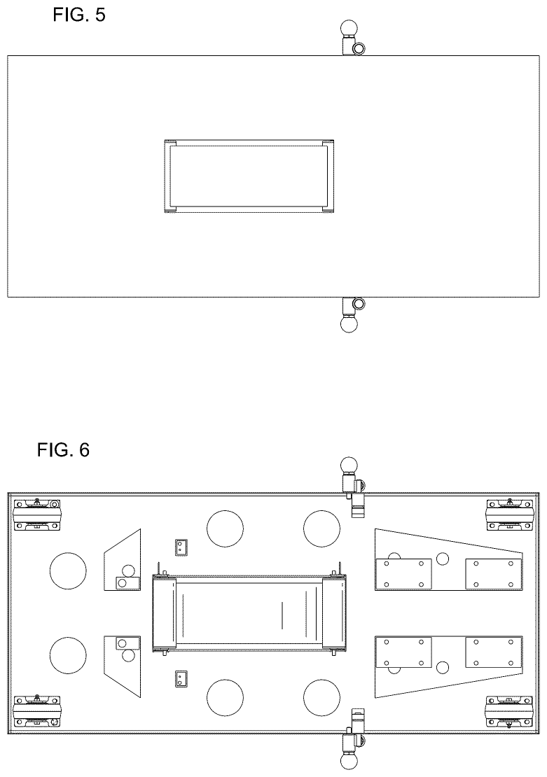

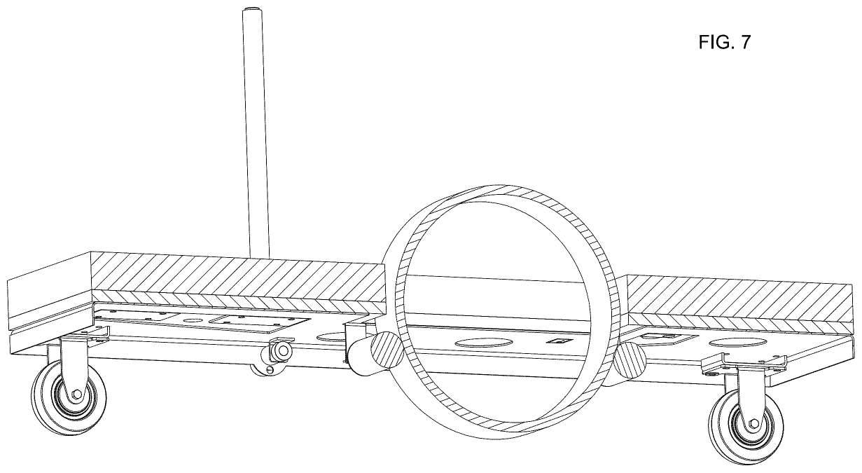

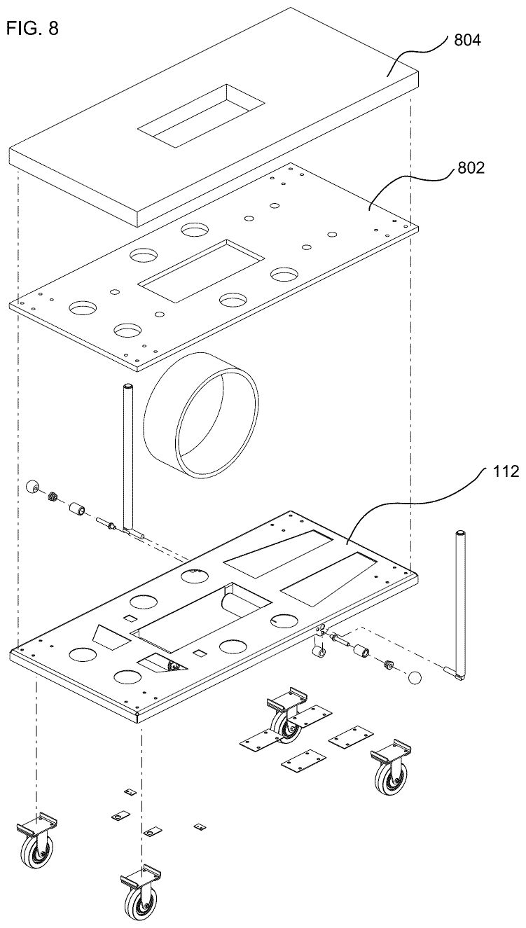

Hereinbelow, the device according to an embodiment of the present disclosure is described with reference to the accompanying drawings. Referring to FIGS. 1-11, the device 100 includes a main body 110 and a yoga wheel 150. The yoga wheel 150 is rotatably supported about a rotation axis by the device such that at least a portion of the yoga wheel 150 is disposed within the opening 124 or hole. The yoga wheel 150 may be replaced with any item that may accomplish the same end goal of spinal and body mobilization. For example, the yoga wheel 150 may be replaced with a foam roller with or without a spinal groove, a ball with or without a spinal groove, or anything similar.

The main body 110 may include a frame 112 or support and a platform 114 disposed on the frame. The frame 112 may support the platform 114. The frame may have a first end 202, a second end 204, a first side 206, and a second side 208. The first end 202 and the second end 204 may be apart from one another in a length direction of the frame. The second end 204 is opposite the first end 202 in the length direction of the frame. The first side 206 and the second side 208 may be apart from one another in a width direction of the frame. The second side 208 is opposite the first side 206 in the width direction of the frame.

When a length direction, a width direction, or a thickness direction is mentioned without reference to what object of direction it is referring to, it may refer to a length direction (i.e., L direction in FIG. 1), a width direction (i.e., W direction in FIG. 1), or a thickness direction (i.e., T direction in FIG. 1) of the frame or the device.

The platform 114 or the main body 110 may include the opening 124 (e.g., a hole, a cutout) within a perimeter of the platform 114 to receive and/or place at least a portion of a yoga wheel 150. In other words, at least a portion of the yoga wheel 150 may be disposed within the opening 124. In the embodiment shown, the frame or support has a corresponding opening 210 or hole that aligns with or coincides with the opening 124 in the platform 114. The side edges or perimeter of the opening 124 may be surrounded/enclosed by the platform 114 such that the opening 124 may be closed off on all sides and be opened through the top and bottom of the platform 114. The opening 124 may be formed generally at the middle of the platform 114. The middle of the platform 114 does not necessarily need to be the exact center of the platform. The middle of the platform 114 may generally refer to an area that is distanced from each edge of the platform. In some embodiments, the opening 124 may be formed slightly or more off from the exact center of the platform 114. For example, the opening may be formed slight off to one end of the platform 114 such that the distance between the opening and one end of the platform may be greater than the distance between the opening and the other end of the platform.

The device may also include a pair of rollers 212, 214, bearings, or the like configured to rotatably support the yoga wheel within the opening. In other words, the pair of rollers 212, 214, bearings, or the like may be configured to allow the yoga wheel 150 to be rotated without changing a position of the rotation axis relative to the device 110. The rotation axis may be generally parallel with the support surface (the upper surface) of the platform 114. The rotation axis may be generally disposed across the opening 124 but does not need to be co-planar with the platform.

The pair of rollers 212, 214 may include a first roller 212 and a second roller 214. The yoga wheel 150 may be placed on the pair of rollers 212, 214 when the yoga wheel is placed on the device through the opening 124. The pair of rollers 212, 214 may be rotatably attached to the frame. In other words, the pair of rollers 212, 214 may be attached to the frame at a fixed position but may rotate while being attached to the fixed position of the frame 122.

The pair of rollers 212, 214 may be positioned below the opening 124, and the pair of rollers 212, 214 may be spaced apart from one another in a length direction of the platform 114. Further, each of the pair of rollers 212, 214 may be positioned adjacent to each end of opening 124 in the length direction. The distance between the one end and the other end of the opening 124 in the length direction may be greater than the distance between the first roller 212 and the second roller 214 in the length direction of the frame 114 such that the yoga wheel 150 may be placed though the opening 124. Also, the distance between the first roller 212 and the second roller 214 in the length direction may be smaller than the diameter of the yoga wheel 150. Thus, the yoga wheel 150 does not pass through the gap in the length direction between the first and second rollers 212, 214 and may instead be supported by the first and second rollers 212, 214 or be placed on (e.g., rest/sit on) the rollers 212, 214. The yoga wheel 150 may be exchanged for a different sized yoga wheel that may pass through the opening 124 and may be placed and/or sit on the pair of rollers 212, 214. During use of the device, the yoga wheel 150 interacts with the rollers 212, 214, allowing the yoga wheel 150 to rotate about its own axis.

The distance between the one end and the other end of the opening 124 in the length direction may be the same or greater than the length of the core of the yoga wheel 150 at the position corresponding to the opening when the yoga wheel 150 is placed on the pair of rollers 212, 214. Thus, the yoga wheel 150 may be placed on and supported by the pair of rollers 212, 214 without interference of the platform 114 (e.g., without contact with the platform 114). In some embodiments, the distance between the one end and the other end of the opening 124 in the length direction may be the same or slightly greater than the diameter of the yoga wheel 150.

The pair of rollers 212, 214 may allow the yoga wheel 150 to be placed thereon to be rotated within an area defined by the opening 124. Further, the pair of rollers 212, 214 may allow the yoga wheel 150 to be rotated without changing a position of the yoga wheel and a position of the rotation axis of the yoga wheel relative to the device 100. In other words, when the yoga wheel is placed on the rollers 212, 214 through the opening 124 and rotated by the user, the yoga wheel may rotate in place without changing its position relative to the device 100. Thus, the yoga wheel may stay placed within the area defined by the opening 124 while a user rotates yoga wheel in practice. When the yoga wheel is placed on the pair of rollers 212, 214, at least one portion of the surface of the yoga wheel 150 may contact and/or interact with at least one portion of the surface of each of the pair of rollers 212, 214. When the yoga wheel 150, while placed on the pair of rollers 212, 214, is rotated by the user, the friction force between the yoga wheel and the pair of rollers 212, 214 causes each of the pair of rollers to rotate to correspond to the rotation of the yoga wheel 150. This interaction allows the yoga wheel to rotate while remaining bound by the opening.

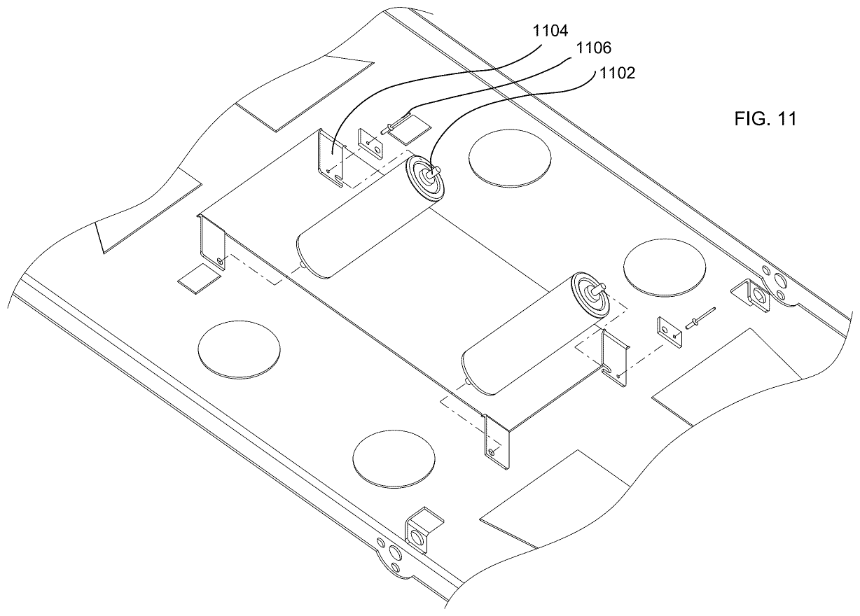

Each of the pair of rollers 212, 214 may be connected to the frame 112 in any suitable matter. For example, referring to FIG. 11, each of the pair of rollers may be connected to the frame using pins 1102 expending from the ends of the roller, brackets 1104, a brace with holes, a flange with holes, and/or a fixing pin 1106.

The pair of bearings may be similarly configured to rotatably support the yoga wheel within the opening. The pair of bearings can each include multiple bearings placed side by side across the opening to contact the surface of the yoga wheel.

Although the pair of rollers and the pair of bearings are described above, in some embodiments, the pair of rollers to interact with the yoga wheel, the pair of bearing, or other, similar device may not be necessary for the device 100 to be fully usable.

Referring to FIGS. 1-9, the device 100 may further include a plurality of wheels 126 configured to movably support the device on a surface (e.g., a floor). For example, the device may include four wheels 126 with one each connected to each of four corners of the main body 110 (e.g., the four corners of the frame 112). The number of wheels 126 is not limited, such that the device 100 may include less or more than the four wheels. Each of the wheels 126 may be coupled to the main body 110 in any suitable matter. For example, each of the wheels 126 may be coupled to the main body 110 using a brace, bolts, nuts, and the like. The wheels 126 allow the device to be moved easily (e.g., with less friction) along the surface on which the device 100 is placed. The wheels 126 may also allow the main body 110 (e.g., the platform 114) to be located at a certain height (e.g., by lifting up the main body) from the surface to provide enough space to accommodate the part of the yoga wheel 150 through the opening 124. Thus, only part of the yoga wheel 150 would protrude from the support surface (i.e., upper surface) of the platform 114. The elevated platform 114 may also provide the user with a fine control of the device. The wheels 126 may be configured to swivel and/or may be designed to be selectively braked to prevent rotation, as desired.

The device 100 may further include a first bar 132 connected to the first side 206 of the main body 110 (e.g., the frame or the platform) and a second bar 134 connected to the second side 208 of the main body 110 (e.g., the frame or the platform). The first bar 132 and the second bar 134 each may be positionable in an upright configuration. In the upright configuration, each of the first and second bars 132, 134 extends vertically upward beyond the upper surface of platform 114 such that the user may engage with, i.e., grasp, the first bar 132 and/or the second bar 134 when using the device 100. Each of the first and second bars 132, 134 may include a rigid pole 136 and a cover 138 surrounding the ride pole. The cover may prevent slipping and protect the user.

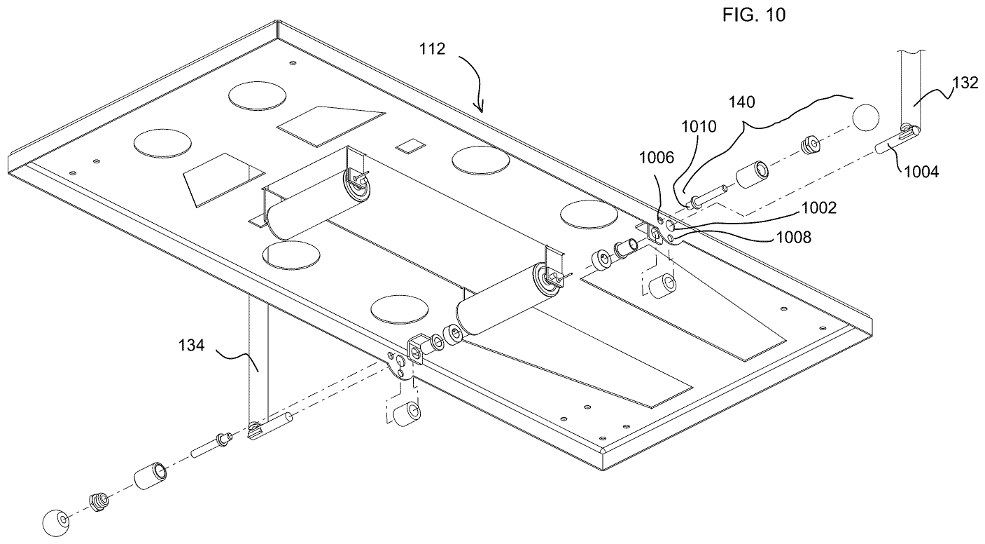

The first bar 132 and second bar 134 may be selectively and respectively movable between the upright configuration and a horizontal or stowed configuration. In the horizontal configuration, the first bar and second bar may be generally parallel with the main body 110 (i.e., generally parallel with the platform, the frame, or both). The configuration of the first bar 132 and second bar 134 may be selectively adjusted and fixed using a latch device 140. Referring to FIG. 10, the frame 112 may include bar holes 1002 each to receive a pin 1004 extending from each of the first bar 132 and the second bar 134. To adjust the configuration of the first bar 132, the frame may also include a first latch hole 1006 to receive a pin 1010 of the latch device 140 coupled to the first bar 132 when the first bar is in the upright configuration. The frame 112 may also include a second latch hole 1008 to receive the pin 1010 of the latch device 140 coupled to the first bar 132 when the first bar 132 is in the horizontal configuration. In other words, by changing the location of the latch device 140 (e.g., the pin of the latch device) between the first latch hole 1006 and the second latch hole 1008, the configuration of the first bar 132 may be changed between the upright configuration and the horizontal configuration. The second bar 134 and its latch device 140 may be similarly configured and operated.

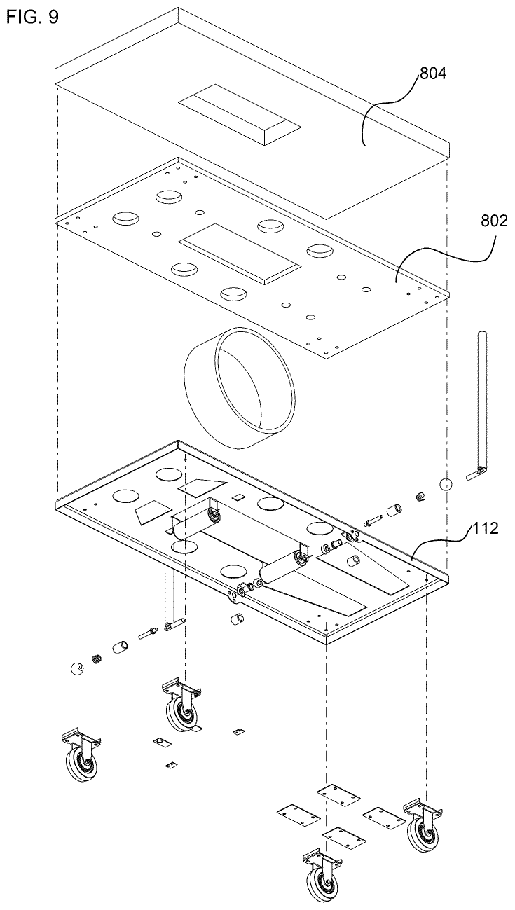

Referring to FIGS. 8 and 9, the platform 114 may include a rigid board 802 (e.g., a rigid panel or plank) that is connected to the frame 112. The rigid board 802 may be coupled to the frame 112 in any suitable matter, for example, using bolts and nuts. The rigid board 802 may provide the necessary strength and support to withstand weight and pressure during use. The platform 114 also includes a support cushion 804 placed on an upper side of the rigid board 802 to provide comfort to the user when the user lies or leans on it. The support cushion 804 may be attached to the rigid board 802 in any suitable manner.

A user may sit on the end of the platform 110 and lean back over the yoga wheel 150 placed on the device 100 while keeping the hips down and the feet on the floor.

When the user leans against the yoga wheel 150, the user may grab the first bar 132 and/or the second bar 134 to balance his/her body. The user may also lift the hips up to increase the intensity. The user may further drop the head back. To massage or stretch another part of body, the user may move the device 100 by rolling the wheels 126 by using the feet on the floor, while leaning back over the yoga wheel placed on the device 100. Because the pair of rollers 212, 214 may allow the yoga wheel to rotate, when the user moves the entire device while leaning against the yoga wheel 150, the yoga wheel 150 may rotate within the area defined by the opening 124 without leaving the device, rolling against the back of the user.

The yoga wheel 150 may be removable from the device 100. In other words, the device may be used with/without the yoga wheel 150. The yoga wheel 150 may be usable by a user separate from the device.

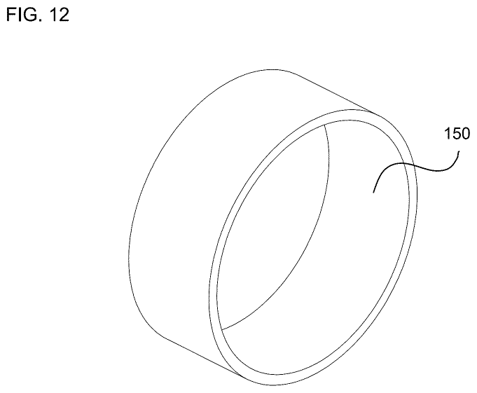

FIG. 12 is a perspective view of the yoga wheel 150 according to an embodiment of the present disclosure. Referring to FIG. 12, the yoga wheel 150 may have a large ring or cylindrical shape. The circumferential outer surface of the yoga wheel may be curved, allowing it to roll. In some embodiments, the core of the yoga wheel 150 may be made from durable materials like plastic or metal. The core may provide the necessary strength and support to withstand weight and pressure during use. In some embodiments, the surface of the yoga wheel 150 may be covered with a layer of cushioning material, gripping material, or shock-absorbing material. This layer may provide comfort and protect the body during the use and/or may aid in allowing the yoga wheel to roll relative to the user's body.

The device 100 may be used for stretching the body and mobilize the spine and other areas/parts of the body with/without the yoga wheel 150. For example, the user may engage with the first bar 132 and/or the second bar 134 with any part of the body such as their hands, arms, elbows, armpits, feet, knees, and/or legs to twist, open, and/or stretch the body. For example, a user may push/pull the first and second bars to apply a force to twist, open, and/or stretch the body.

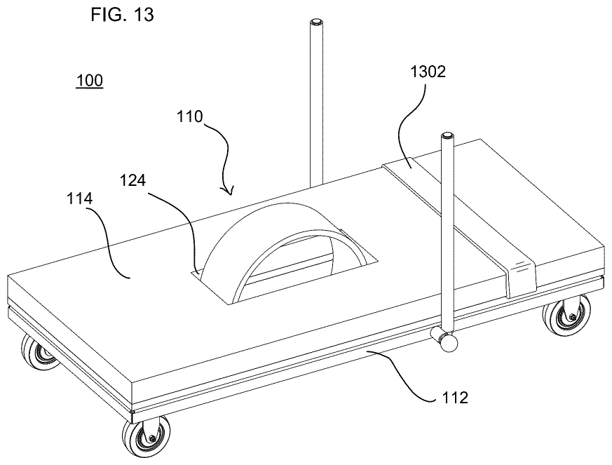

FIG. 13 is a perspective view illustrating the exercise device 100 according to another embodiment of the present disclosure. The exercise device 100 may further include a resistance band 1302 placed on an upper surface of the platform 114 (e.g., the upper surface of the support cushion 804). The resistance band 1302 may be made of elastic material such as rubber. The resistance band 1302 may be fixable to the main body 110 (e.g., the platform 114 and/or the frame 112) via at least two points such that when the resistance band 1302 is stretched away from the upper surface of the platform 114, an elastic force toward the upper surface of platform 114 may be generated.

The device 100 may further include the neck traction device (e.g., neck rest, neck relaxer, neck pillow, cervical traction device, or the like) on which a user may place/rest the back or their neck when they lie down. The neck traction device may be removably placed on the upper surface of the platform. For example, the neck traction device may be placed between the opening 124 and the resistance band 1302. Then, the user may lie down on the platform 114, placing the neck traction device behind the neck to stretch and/or relax the neck. To increase an amount of dragging/traction force applied to the neck while using the neck traction device, the user may stretch the resistance band and place it on the forehead. When the user uses the neck traction device, the user may use the device without the yoga wheel.

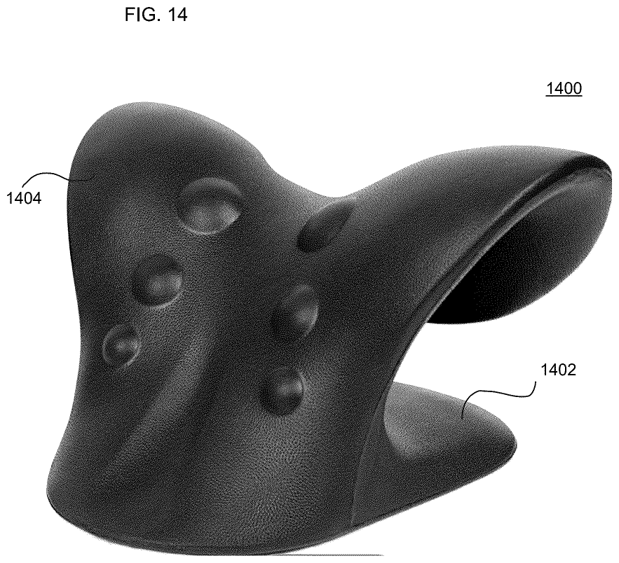

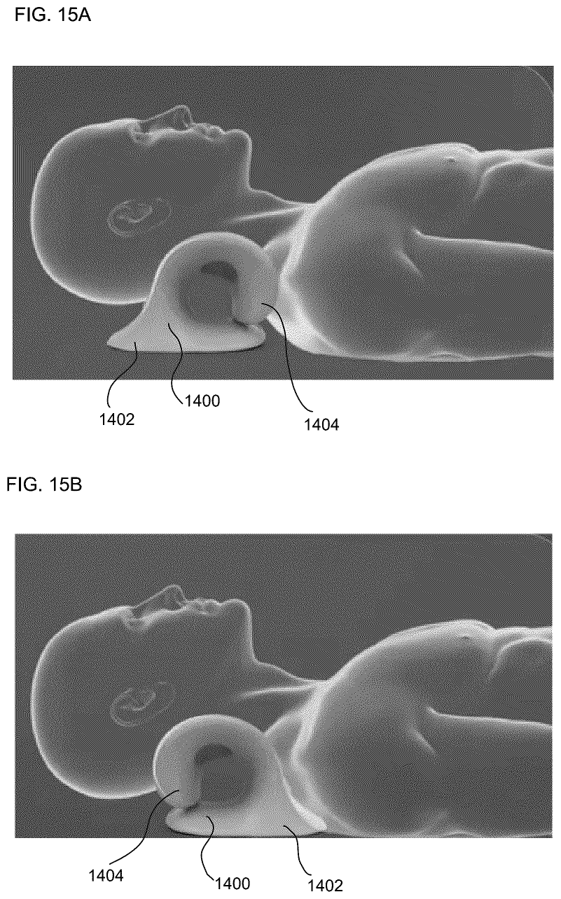

FIG. 14 illustrates an example of the neck traction device 1400 according to an embodiment. FIGS. 15A and 15B illustrate two different ways to use the neck traction device 1400. As illustrated in FIG. 14, the neck traction device 1400 may include a base 1402 and a neck support 1404 extending from the base. The bottom surface of the base 1402 of the neck traction device may be substantially flat to allow the neck traction device to be placed and stand on the supporting surface/upper surface of the platform. The neck support 1404 may extend from the base 1402 and be curved to gently support the neck. The neck traction device may be used in two directions/placements. For example, as shown in FIG. 15A, the neck traction device 1400 may be used in a convex placement (i.e., a convex configuration) in which the open end of the neck support 1404 is positioned near the shoulder of the user and the other end of the neck support, which is connected to the base 1402, is positioned away from the shoulder of the user. As shown in FIG. 15B, the neck traction device may also be used in a concave placement (i.e., a concave configuration) which is rotated 180 degrees in plane of the supporting surface of the platform. In the concave placement, the open end of the neck support 1404 is positioned away from the shoulder of the user and the other end neck support, which is connected to the base 1402, is positioned near the shoulder of the user. The neck traction device 1400 may apply a greater traction force in the concave placement than in the convex placement. For example, the neck traction device 1400 may apply gentle traction, which is suitable for an initial traction, in the convex placement. The next traction device may apply strong traction, which is suitable for stretching cervical spine after the initial traction, in the concave placement.

The device may further include a hook (not shown). The hook may be used to increase a reach of the user to a part of the body. For example, when the user is not flexible enough to hold the body parts (e.g., knees, ankles, and the like) with their hands, the user may use the hook to grab a part of the body and twist and stretch the body. Further, the hook may be used to release tension in muscles, facial adhesions, and other soft tissue limitations from areas all over the body.

Additional uses of the device 100 may include an array of stretches, mobility exercises, strength exercises and soft tissue release exercises/movements that may be performed in unique ways using the device.

The device 100 according to an embodiment of the present disclosure may support body weight contact pressure and provide angle control, during back rolling movement on the yoga wheel placed on the device. The platform 114 elevates the user in relation to the yoga wheel 150. This may allow more gradual and stabilized use of the yoga wheel and increased usability of the yoga wheel for additional mobility exercises, which is not previously possible with conventional yoga wheels. Further, the device 100 may allow fine, controlled movement while using the yoga wheel on the device. The first and second bars 132, 134 on the left and right sides may help stabilization and contact control while using the yoga wheel as well as allow the user to increase the pressure during use.

Further, the device 100 may allow to use the yoga wheel 150 in a stable environment. By using the first and second bars 132, 134, the user may push their body (e.g., the back) to the yoga wheel 150 and increase the intensity with removed or minimized risk of loss of balance and/or risk of injury. The device 100 also allows the user lean from side to side on the yoga wheel 150. Furthermore, the device may allow to apply more torque and deeper rotation in spinal rotation, piriformis stretching, and rotational stretches for the lower back, hips, and legs.

The specification does not necessarily describe all elements of various embodiments of the present disclosure. Descriptions of elements or components well-known in the art to which the present disclosure pertains or overlapping or repetitive descriptions have been omitted.

It should be understood that, when an element is referred to as being “connected” to another element, it can be directly or indirectly connected to the other element. An indirect connection includes one or more intervening elements or parts among or between two connected elements.

It should be understood that the terms “include,” “comprise”, “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element or, yet another element may be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, the terms “up,” “upward,” “down,” “downward,” and the like are used for reference as relative directional terms. It should be understood that these terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

Although the technical concepts or the disclosure have been described in detail with reference to embodiments thereof, the scope of the present disclosure is not limited to the embodiments. It should be appreciated by those having ordinary skill in the art that changes may be made in these embodiments without departing from the principles and spirit of the disclosure, the scope of which is defined in the appended claims and equivalents thereto.

What is claimed is:

1. A device for increasing mobility and flexibility of a body including a spine, the device comprising:
a frame;
a platform disposed on the frame and having an opening; and
an arcuate body rotatably supported about a rotation axis by the device such that at least a portion of the arcuate body is disposed within the opening.

2. The device of claim 1, wherein the frame has an opening that is aligned with or coincides with the opening in the platform.

3. The device of claim 1, further comprising one or more rollers configured to rotatably support the arcuate body within the opening.

4. The device of claim 3, wherein the arcuate body merely rests on the one or more rollers.

5. The device of claim 3, wherein the arcuate body interacts with the one or more rollers.

6. The device of claim 3, wherein the one or more rollers allows the arcuate body to be rotated within an area defined by the opening.

7. The device of claim 3, wherein the one or more rollers is configured to allow the arcuate body to be rotated without changing a position of the rotation axis relative to the device.

8. The device of claim 1, wherein the arcuate body is a yoga wheel and is removable from and usable by a user separate from the device.

9. The device of claim 1, further comprising a first bar and a second bar each positionable in an upright configuration extending vertically upward beyond the platform.

10. The device of claim 9, wherein the first bar is connected to a first side of the frame, and wherein the second bar is connected to a second side of the frame opposite the first side.

11. The device of claim 9, wherein the first bar and the second bar are selectively movable between the upright configuration and a horizontal configuration.

12. The device of claim 11, wherein the first bar and the second bar are generally parallel with the platform in the horizontal configuration.

13. The device of claim 1, further comprising a resistance band configured to be placed on an upper surface of the platform, wherein the resistance band is fixable to at least one of the platform or the frame via at least two points.

14. The device of claim 1, wherein the platform includes a board or plank and a support cushion on an upper side of the board or plank.

15. The device of claim 1, further comprising a plurality of wheels connected to the device and configured to movably support the device on a surface.

16. A device for increasing mobility and flexibility of a body, the device comprising:
a platform having an opening within a perimeter of the platform; and
a yoga wheel rotatably supported for rotation such that at least a portion of the yoga wheel is disposed within the opening.

17. The device of claim 16, wherein the yoga wheel rotates about a rotation axis that is parallel with a support surface of the platform.

18. The device of claim 17, wherein the rotation axis is disposed across the opening though not necessarily co-planar with the platform.

19. The device of claim 16, further comprising a neck traction tool configured to be removably placed on an upper surface of the platform such that a user can position the neck traction tool behind the user's neck to stretch or relax the neck when the user lies down on the platform.

20. The device of claim 16, further comprising a hook coupled to the device and configured to be used to increase a reach of a user to a part of the body or release tension in muscles, facial adhesions, and other soft tissues limitations from all areas over the body.
